(19) United States
(12) Patent Application Publication
(10) Pub. No.: US 2026/0077388 A1
(43) Pub. Date: Mar. 19, 2026

(54) PIEZOELECTRIC DRIVER WITH SWITCHED PARASITIC RESONATOR

(71) Applicant: SEMICONDUCTOR COMPONENTS INDUSTRIES, LLC, Scottsdale, AZ (US)

(72) Inventors: Pavel HORSKY, Brno (CZ); Pavel BAROS, Zastavka u Brna (CZ)

(73) Assignee: SEMICONDUCTOR COMPONENTS INDUSTRIES, LLC, Scottsdale, AZ (US)

(21) Appl. No.: 18/888,074

(22) Filed: Sep. 17, 2024

(51) Int. Cl. B06B 1/02

(52) U.S. Cl. CPC B06B 1/0223

(57) ABSTRACT

An actuator comprises an output stage configured to alternately couple an output node to a first supply voltage and a second supply voltage, and to isolate the output node when an inhibit signal is asserted. A piezoelectric element has two terminals coupled by a parasitic capacitance C_{P}, with one terminal coupled to the output node. A switched inductance path between the two terminals includes an inductor in series with a switch. A control circuit is configured to close the switch as needed to substantially invert a charge on the parasitic capacitance before the output stage couples the first or second supply voltage to the output node. The second terminal may be coupled to ground, with the supply voltages having equal magnitude but opposite polarity.

### TECHNICAL FIELD

The present disclosure relates to piezoelectric element drivers, and more particularly to a driver with a switched parasitic resonator that enables enhanced driving efficiency.

### BACKGROUND

Piezoelectric elements are widely used, particularly in connection with ultrasonic sensing and cleaning systems. The appeal of such systems is dependent upon their effectiveness, cost, and efficiency, which are preferably maintained across a wide range of operating conditions.

Conventional piezoelectric drivers typically employ a half-bridge configuration to alternately apply positive and negative voltages to the piezoelectric element. However, this approach faces challenges when dealing with the parasitic capacitance inherent in piezoelectric transducers. The parasitic capacitance requires charging and discharging during each cycle of operation, which can lead to significant power losses that increase at higher frequencies and voltages.

The power dissipation resulting from charging and discharging the parasitic capacitance can cause substantial heating of the driver circuitry. This thermal issue is particularly problematic in compact electronic assemblies, such as those found in automotive camera modules, where opportunities to facilitate heat dissipation are limited. The heat generated can potentially affect the reliability and performance of the overall system.

Ultrasonic cleaning systems capable of cleaning external surfaces may be most effective at high frequencies and power levels (e.g., frequencies up to 1 MHz and power levels up to 15 W), posing a particularly difficult heat dissipation challenge. As automotive and other industries continue to incorporate more advanced sensing and cleaning technologies, there is a growing need for piezoelectric driving solutions that can address these challenges.

### SUMMARY

Accordingly, there are provided herein actuators employing enhanced piezoelectric element drivers and driving methods that may provide enhanced efficiency, reduced power consumption, and reduced heat dissipation challenges. One illustrative actuator includes an output stage configured to alternately couple an output node to a first supply voltage and a second supply voltage. The output stage can also isolate the output node from both supply voltages when an inhibit signal is asserted. The actuator includes a piezoelectric element with two terminals coupled by a parasitic capacitance C_{P}, where one terminal is connected to the output node. A switched inductance path is provided between the two terminals, including an inductor in series with a switch. A control circuit is configured to close the switch as needed to substantially invert a charge on the parasitic capacitance before the output stage couples either supply voltage to the output node.

A method of driving a piezoelectric element with a parasitic capacitance between its two terminals is also provided. The method involves coupling a first terminal to a first supply voltage to charge the parasitic capacitance, decoupling the first terminal, enabling an inductive path between the terminals to substantially invert the voltage, disabling the inductive path, and coupling the first terminal to a second supply voltage to finish inverting the voltage.

Another actuator is provided that includes a piezoelectric element with two terminals coupled by a parasitic capacitance C_{P}. A first transistor couples a first terminal to a first supply voltage to charge the parasitic capacitance and decouples it in response to a clock signal transition. A switched inductance path between the terminals substantially inverts the voltage in response to the transition and disables the path when its current returns to zero. A second transistor couples the first terminal to a second supply voltage to finish inverting the voltage after the inductive path current returns to zero.

The actuators and method may include one or more of the following optional features: 1. the method may further include: decoupling the first terminal from the second supply voltage; enabling the inductive path between the two terminals to substantially restore the voltage of the parasitic capacitance; disabling the inductive path; and coupling the first terminal to the first supply voltage to finish restoring the voltage of the parasitic capacitance. 2. the decoupling and enabling operations are initiated by transitions in a clock signal. 3. the disabling and coupling operations are enabled by a current sensor in the inductive path. 4. the inductive path has an inductance L_{X} less than 1/(2πf_{D})²C_{P}, where f_{D} is a drive frequency of the clock signal. 5. the inductive path has an inductance L_{X} less than 1/(2πf_{C})²C_{P}, where f_{C} is a characteristic resonance frequency of the piezoelectric element. 6. the second terminal is coupled to a ground voltage, and the first supply voltage and the second supply voltage have a same magnitude but opposite polarity relative to the ground voltage. 7. the piezoelectric element has a characteristic resonance frequency f_{C}=1/2π(L_{S}C_{S})^{1/2}. 8. the control circuit asserts the inhibit signal and closes the switch for each transition in the clock signal. 9. the switched inductance path includes a current sensor configured to sense a current through the switched inductance path. 10. The actuator of claim 8, wherein the control circuit is configured to de-assert the inhibit signal and open the switch when the current reaches zero.

### BRIEF DESCRIPTION OF FIGURES

FIG. 1A is a cross-sectional view of an illustrative camera with a self-cleaning function.

FIG. 1B is a top view of a circuit substrate for the illustrative camera of FIG. 1A.

FIG. 2A is a circuit diagram for an illustrative piezoelectric element driver.

FIG. 2B is a graph showing an illustrative clock signal as a function of time.

FIG. 3 is a circuit diagram for an enhanced piezoelectric element driver.

FIG. 4 is a timing diagram for various signals in an illustrative piezoelectric element driving circuit.

FIG. 5 is a flow diagram of an illustrative piezoelectric element driving method.

FIG. 6 is a circuit diagram for an illustrative switched inductance path implementation.

FIG. 7 is a circuit diagram for an illustrative control circuit implementation.

FIG. 8 is a circuit diagram for an illustrative piezoelectric element driver having an alternative configuration.

FIG. 9 is a circuit diagram for an enhanced piezoelectric element driver using the alternative configuration.

### DETAILED DESCRIPTION

The drawings and following description do not limit the disclosure, but on the contrary, they provide the foundation for one of ordinary skill in the art to understand all modifications, equivalents, and alternatives falling within the scope of the claim language. Vehicle camera modules are used to provide an explanatory context, but the principles can be applied to any piezoelectric element drivers where enhanced efficiency is desired.

The present disclosure provides a piezoelectric element driver with a switched parasitic resonator. This driver is designed to enhance the efficiency of piezoelectric element-based actuators and devices, particularly in ultrasonic sensing and cleaning systems that may need to operate at high frequency (above, e.g., 100 kHz) and high voltage (above, e.g., 15V). In a typical piezoelectric element having a resonant impedance on the order of 10 ohms, 17.5 volts would correspond to a drive power of roughly 15 W.

The driver includes an output stage that couples to a piezoelectric element, a switched inductance path, and a control circuit. The output stage is configured to alternately couple an output node to a first supply voltage and a second supply voltage, and to isolate the output node when an inhibit signal (also herein referred to as a blanking signal) is asserted. The piezoelectric element has two terminals coupled by a parasitic capacitance, with one terminal coupled to the output node. The switched inductance path is provided between the two terminals, including an inductor in series with a switch. The control circuit is configured to close the switch as needed to substantially invert a charge on the parasitic capacitance before the output stage couples the first or second supply voltage to the output node. This configuration may allow for enhanced efficiency, reduced power consumption, and reduced heat dissipation, and may be particularly suited for use in compact electronic assemblies such as those found in automotive camera modules. In some cases, the driver may be used in ultrasonic cleaning systems for camera lenses.

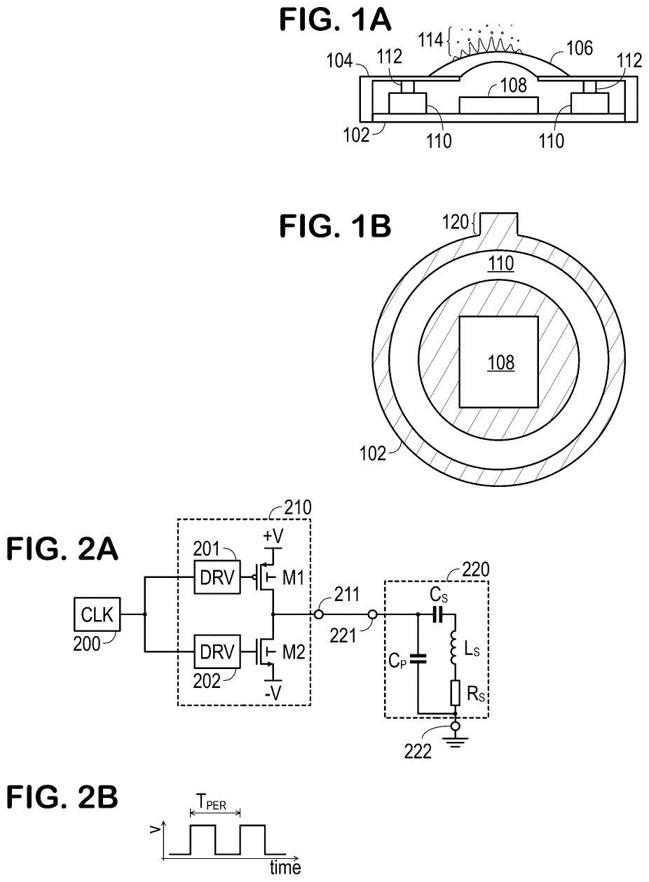

Referring to FIG. 1A, a cross-sectional view of a camera with a self-cleaning function is shown. The camera includes a circuit substrate 102, which serves as a base for the electronics and other components. The circuit substrate 102 may be, e.g., a printed circuit board, an electronics package substrate, or a molded portion of the device casing to which the electronics may be mounted. A case 104 encloses the internal components and provides structural support. The case 104 may include an aperture over which a lens 106 is mounted to focus an image on an image sensing portion of the device electronics. The lens 106 may be exposed to the external environment.

An integrated circuit 108 with an image sensor is mounted on the circuit substrate 102. The integrated circuit 108 may include a piezoelectric element driver and other control electronics for the camera. Adjacent to the integrated circuit 108 is one or more piezoelectric elements 110, which can generate vibrations for cleaning the lens 106.

The illustrated device includes one or more ribs or other buttressing elements 112 that mechanically couple the piezoelectric element(s) 110 to the supporting surface for the lens 106. This communicates ultrasonic vibrations from the piezoelectric element to the lens and its supporting surface, providing mechanical energy to separate water, ice, dust, dirt, mud, or the like, from the surface of the lens 106. The mechanical energy of the vibrations may further operate to melt, disintegrate, and/or disperse the surface contaminants. A vibrating droplet 114 is shown on the surface of the lens 106, representing moisture or debris that the device is designed to remove. The desired vibration frequency may be in the range from 20 kHz to 1 MHz, with a drive signal power in the range from 1 W to 100 W, or in certain contemplated implementations, from 5 W to 20 W. The piezoelectric element may be chosen to have a characteristic resonance frequency suitable to the desired application, may be designed to provide a broad frequency response range, or may be given supporting components that provide an adjustable resonance frequency or multiple usable resonance frequencies.

The arrangement of components allows for a compact design where the piezoelectric element 110 can effectively transmit vibrations to the lens 106 for cleaning purposes, while the integrated circuit 108 controls the operation of the device. In other cases, the piezoelectric element 110 may be positioned in different locations within the device, or multiple piezoelectric elements may be used, depending on the specific requirements of the application. In at least some embodiments, additional discrete components are provided on the circuit substrate 102 to support operation of the integrated circuit 108 and/or to interface with the piezoelectric element 110.

Referring to FIG. 1B, a top view of the circuit substrate 102 is illustrated. In some contemplated embodiments, the piezoelectric element 110 is in the form of a circular ring mounted on the circuit substrate 102. The piezoelectric element 110 may surround the integrated circuit 108.

In some cases, the circuit substrate 102 includes a tab 120 configured as an edge connector. The tab 120 may be printed with gold finger contacts and be configured to connect external wiring to the device electronics. This arrangement allows for easy connection and disconnection of the device from external systems, such as wiring to receive power and communicate with an external controller or host system. In other cases, the tab 120 may be replaced with other types of connectors or interfaces, depending on the specific requirements of the application.

Referring to FIG. 2A, a basic circuit configuration for driving a piezoelectric element is illustrated. The circuit includes an output stage 210, a piezoelectric element 220, and a clock signal source 200. The output stage 210 is configured to alternately couple an output node 211 to a first supply voltage (+V) and a second supply voltage (−V) at a frequency determined by the clock signal.

The piezoelectric element 220 has two terminals 221, 222 coupled by a parasitic capacitance C_{P}. The first terminal 221 is coupled to the output node 211 of the output stage 210. The second terminal 222 is coupled to a ground voltage node. The first supply voltage and the second supply voltage may have the same magnitude but opposite polarity relative to the ground voltage. In one contemplated embodiment, the first and second supply voltages are +35 volts and −35 volts, respectively.

The illustrated output stage 210 includes a PMOS driver 201 and an NMOS driver 202. These drivers are connected to transistors M1 and M2, respectively. The first transistor M1 is a PMOS transistor that selectively connects a positive voltage supply (+V) to the output node 211, while the second transistor M2 is an NMOS transistor that selectively connects a negative voltage supply (−V) to the output node 211. The clock signal source 200 provides input to both the PMOS driver 201 and the NMOS driver 202, providing timing signals for the circuit operation.

To support higher voltage operation, the first and second transistors M1 and M2 may be DDMOS (double-diffused metal oxide semiconductor) transistors. Other types of high-voltage transistors, such as LDMOS (lateral diffused metal oxide semiconductor) transistors or VDMOS (vertical diffused metal oxide semiconductor) transistors, may alternatively be used. Though M1 is shown here as a PMOS transistor, we note that it can alternatively be implemented as an NMOS transistor, offering a smaller size or lower on resistance with the trade off that an additional supply voltage may be needed to drive a high-side NMOS transistor, but such additional voltages can be readily achieved by, e.g., using a bootstrap capacitor. The choice of transistor types may depend on factors such as the desired operating frequency, power level, and efficiency, as well as the available space and thermal management capabilities of the device.

The piezoelectric element 220 is represented by an equivalent circuit model consisting of a series combination of capacitance C_{S}, inductance L_{S}, and resistance R_{S} between the two terminals 221, 222, yielding a characteristic resonance frequency for the piezoelectric element of f_{C}=1/2π(L_{S}C_{S})^{1/2}. The clock signal driving frequency f_{D} may be chosen to correspond with this characteristic resonance frequency as this correspondence may yield more efficient conversion to mechanical energy. Where the piezoelectric element 220 has multiple resonance frequencies, any one of the resonance frequencies may be treated as a characteristic resonance frequency.

Additionally, a parasitic capacitance C_{P} is shown between the two terminals in parallel with the series combination. The parasitic capacitance is typically substantially larger than the series capacitance, e.g., more than 1000× larger, and may represent a dominant source of power loss when the piezoelectric element is driven with a high frequency oscillation, necessitating current flow sufficient to discharge and recharge this parasitic capacitance many times per second. In one contemplated implementation, the parasitic capacitance is 1.3 nF. With a 70-volt swing (between +35 and −35 volts) and a 400 kHz drive frequency, the current consumption by the parasitic capacitance represents at least 2.5 W of unproductive power dissipation in the output stage transistors.

Referring to FIG. 2B, a waveform of the clock signal is depicted. The vertical axis represents voltage V and the horizontal axis represents time. The clock signal alternates between a high and low voltage state, representing logical high and logical low, respectively. The waveform consists of sharp transitions between the high and low states, forming a rectangular shape that repeats periodically. The period of the clock signal is labeled as T_{PER}, corresponding to the inverse of the drive frequency f_{D}.

The output stage 210 of FIG. 2A is configured to operate based on this clock signal. When the clock signal is asserted, the PMOS driver disables transistor M1, decoupling the output node 211 from the positive supply voltage. The NMOS driver 202 enables transistor M2, connecting the output node 211 to the negative supply voltage, drawing the voltage of the output node to the negative supply voltage. When the clock signal is de-asserted, the NMOS driver 202 disables transistor M2, decoupling the output node 211 from the negative supply voltage. The PMOS driver 201 enables transistor M1, connecting the output node 211 to the positive supply voltage and raising the voltage of the output node to the positive supply voltage. In this fashion, output stage 210 alternately couples the output node 211 to the positive and negative supply voltages, driving the piezoelectric element 220 but also wasting power charging and discharging the parasitic capacitance.

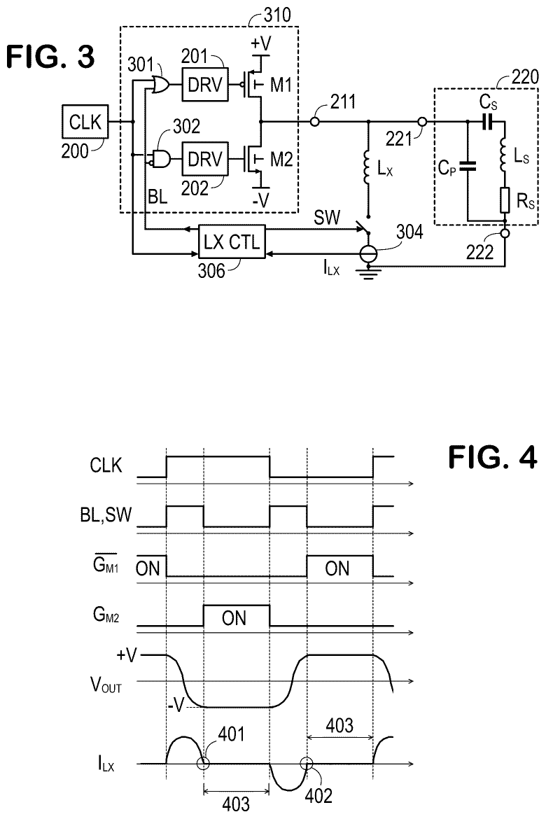

Referring to FIG. 3, an enhanced piezoelectric element driver circuit is illustrated. The circuit includes an output stage 310, a piezoelectric element 220, a switched inductive path, and associated control components. The output stage 310 includes a PMOS driver 201 and an NMOS driver 202, which are connected to transistors M1 and M2, as before, to alternately connect to the output node 211 to the positive and negative supply voltages with timing based at least in part on the clock signal.

However, output stage 310 further includes a logical OR gate 301 and a logical AND gate 302, which each predicate the operation of their respective driver 201, 202 on the state of a blanking signal BL. When the blanking signal is asserted, the output of logical OR gate 301 is held high, preventing PMOS driver 201 from enabling transistor M1 even if the clock signal is de-asserted. Similarly, the output of logical AND gate 302 is held low, preventing NMOS driver 202 from enabling transistor M2 even if the clock signal is asserted. When asserted, blanking signal BL thus inhibits the operation of transistors M1, M2, placing the output stage 301 in a high impedance (Hi-Z) state isolating the output node 211 from both supply voltages. When the blanking signal BL is de-asserted, the gates 301, 302 enable the clock signal to control the state of the output stage.

FIG. 3 also shows a switched inductance path between the two terminals 221, 222 of the piezoelectric element 220. This path includes an inductor L_{X} in series with a switch SW and a current sensor 304. The switch is closed when the output stage 310 is in a high impedance state. When closed, the switch enables the parasitic capacitance C_{P} to discharge through inductor L_{X}, converting the voltage on the parasitic capacitance to a current through the inductor. The switch is kept closed until the inductor current serves to recharge the parasitic capacitance to the opposite voltage. When the current sensor 304 detects that the inductor current has substantially returned to zero, the control circuit 306 opens the switch, disabling any reverse current flow. In this way, the switched inductive path operates to substantially invert the charge on the parasitic capacitance. There is some loss to the serial components of the equivalent circuit, which can be replenished by the output stage 310 after the switched inductive path is disabled.

A control circuit 306 is configured to receive input from a clock signal source 200 and an inductor current measurement signal I_{LX} from sensor 304, and to responsively provide the blanking signal BL to logic gates 301, 302 to inhibit activation of output stage transistors M1, M2, as well as a signal to control the operation of the switch SW.

In operation, the output stage 310 couples a first terminal 221 of the piezoelectric element 220 to a first supply voltage to charge the parasitic capacitance C_{P} to a voltage relative to a second terminal of the piezoelectric element 220. The output stage 310 then decouples the first terminal 221 from the first supply voltage. The control circuit 306 enables the inductive path between the two terminals 221, 222 to substantially invert the voltage of the parasitic capacitance C_{P}. The control circuit 306 then disables the inductive path, and the output stage 310 couples the first terminal 221 to a second supply voltage to finish inverting the voltage of the parasitic capacitance C_{P}. As most of the inversion is accomplished by the switched impedance path, the power demand on the output stage is substantially reduced.

The operation of the enhanced piezoelectric element driver circuit continues with the second half of the driving cycle, where the charge on the parasitic capacitance C_{P} is restored to its initial state. After the output stage 310 has finished inverting the voltage of the parasitic capacitance C_{P} by coupling the first terminal of the piezoelectric element 220 to the second supply voltage, the output stage 310 decouples the first terminal 221 from the second supply voltage. This decoupling operation may be initiated by a transition in the clock signal from the clock signal source 200, which is detected by the control circuit 306.

Following the decoupling operation, the control circuit 306 enables the inductive path between the two terminals 221, 222 of the piezoelectric element 220 to substantially restore the voltage of the parasitic capacitance C_{P}. The inductive path includes the inductor L_{X} and the switch SW, which is closed by the control circuit 306. When the switch SW is closed, the inductor L_{X} is connected in series with the parasitic capacitance C_{P}, forming a resonant circuit that allows the charge on the parasitic capacitance C_{P} to convert to inductor current and thence to a restored voltage on the parasitic capacitance. This operation effectively restores the voltage of the parasitic capacitance C_{P} to its initial state, with a small loss to the serial components of the equivalent circuit.

The control circuit 306 monitors the current through the inductor L_{X} using the current sensor 304. When the current sensor 304 detects that the current through the inductor L_{X} has returned to zero, indicating that the charge on the parasitic capacitance C_{P} has been substantially restored, the control circuit 306 disables the inductive path by opening the switch SW.

Finally, the output stage 310 couples the first terminal of the piezoelectric element 220 to the first supply voltage to finish restoring the voltage of the parasitic capacitance C_{P}. This coupling operation may be initiated by the control circuit 306, which de-asserts the inhibit signal and allows the output stage 310 to respond to the clock signal from the clock signal source 200. The coupling operation completes the driving cycle and prepares the piezoelectric element 220 for the next cycle of operation.

The output stage decoupling and inductive path enabling operations may be initiated by transitions in the clock signal from the clock signal source 200, and the inductive path disabling and output stage coupling operations may be enabled by the current sensor 304 in the inductive path. This arrangement enables efficient reuse of the stored energy on the parasitic capacitance, thereby reducing power dissipation in the output stage transistors.

Referring to FIG. 4, a timing diagram is shown that illustrates the interaction of various signals in the piezoelectric element driver circuit. The diagram includes waveforms for a clock signal (CLK), a blanking signal BL (which in this example is the same as the switch control signal SW), gate control signals G_{M1}, G_{M2} for two transistors (M₁ and M₂), an output node voltage (V_{OUT}), and an inductor current (I_{LX}). The inductor current I_{LX} waveform shows two points where the current reaches zero, labeled as first current zero 401 and second current zero 402. These zero current points 401 and 402 correspond to the transitions in the other signals, indicating the timing of the circuit's operation as it switches between use of the output stage and the switched inductive path for charging and discharging the piezoelectric element.

The output stage decoupling and inductive path enabling operations are initiated by transitions in the clock signal. For instance, when the clock signal transitions from a low state to a high state, the first transistor M1 is turned off, decoupling the first terminal of the piezoelectric element 220 from the first supply voltage. Simultaneously, the switch SW in the switched inductance path is closed, enabling the inductor L_{X} to invert the charge of the parasitic capacitance C_{P} of the piezoelectric element 220 as shown by the V_{OUT} signal dropping to zero as the inductor current increases to a peak, and is thereafter charged to the opposite voltage by the inductor current. When the current through the inductor L_{X} reaches zero (or falls below a predetermined threshold near zero) at point 401, the switch SW is opened, isolating the two terminals of the piezoelectric element 220. This prevents any reverse current flow through the inductor L_{X}, preserving the charge on the parasitic capacitance C_{P}. At the same time, the blanking signal BL is de-asserted, disabling the inductive path and enabling transistor M2 to couple the output node to the negative supply voltage, replenishing any losses to the serial components and thereby finishing the charge inversion.

When the clock signal later transitions from the high state to the low state, the second transistor M2 is turned off, decoupling the first terminal of the piezoelectric element 220 from the second supply voltage. Simultaneously, the switch SW in the switched inductance path is closed again, enabling the inductor L_{X} to discharge and charge the parasitic capacitance C_{P} of the piezoelectric element 220 in the opposite direction. The switched inductance path substantially restores the voltage of the parasitic capacitance C_{P} in response to the second transition in the clock signal. When the inductor current reaches zero (or exceeds a predetermined threshold near zero) at point 402, the switch SW is opened to prevent further current flow through the inductor and preserve the restored charge on the parasitic capacitance. At the same time, the blanking signal is de-asserted, enabling transistor M1 to couple the output node to the positive supply voltage, replenishing any loss to the serial components of the equivalent circuit and finishing the charge restoration.

FIG. 4 shows a delay 403 between the return-to-zero points 401, 402 and the subsequent clock signal transition. Larger values of the switched inductance L_{X} will reduce or (under adverse process, voltage, and temperature variations) potentially eliminate this delay 403. If delay 403 is eliminated, the inductive path will be unable to complete the charge inversions before a subsequent inversion is needed, preventing proper operation of the driver. The circuit design may provide for a delay large enough to ensure that at least some delay 403 is maintained for all process, voltage, and temperature variations. In any case, the value of the switched inductance should be limited to less than 1/(2πf_{D})²C_{P}, where f_{D} is the drive frequency of the clock signal, and preferably to a half, a third, a quarter, or perhaps a tenth of that limit. Inductance values that are too small will increase the current flow through the inductors and the switch SW, causing undesirable power losses due to the inherent resistance of these components. In one illustrative implementation, the switched inductance is 1 to 2 μH, and may be implemented as a discrete electronic component on the circuit substrate 102. Where the drive frequency corresponds to the characteristic resonance frequency of the piezoelectric element f_{C}, this limit may be expressed as 1/(2πf_{C})²C_{P}. This ensures that the inductor L_{X} can effectively discharge and charge the parasitic capacitance C_{P} within each half period of the clock signal.

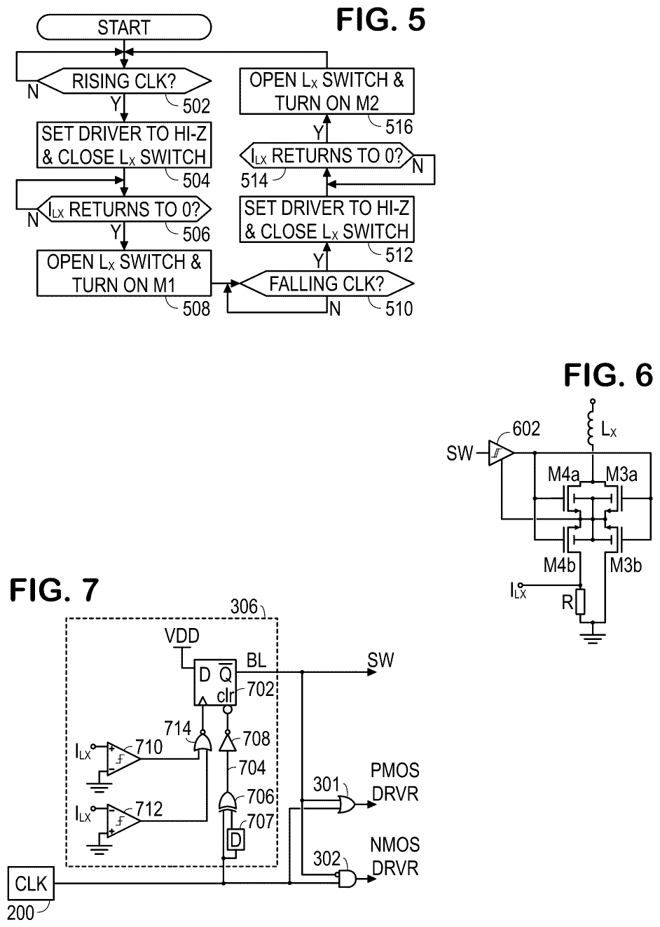

Referring to FIG. 5, a flowchart shows an illustrative sequence of operations for driving the piezoelectric element. The process begins with a rising clock edge detection block 502, which checks for a rising edge in the clock signal. If a rising edge is detected, the process moves to an inductive path activation block 504. In this block, the driver is set to a high-impedance state and an inductive path switch is closed, enabling the inductor L_{X} to discharge and oppositely charge the parasitic capacitance C_{P} of the piezoelectric element 220.

The process then proceeds to a zero current detection block 506, which checks if the current I_{LX} through the inductor L_{X} has substantially returned to zero. When I_{LX} reaches zero, indicating that the charge on the parasitic capacitance C_{P} has been substantially inverted, a driver activation block 508 is activated. This block opens the inductive path switch, disabling the path, and turns on the first transistor M1, coupling the first terminal of the piezoelectric element 220 to the first supply voltage to finish inverting the voltage of the parasitic capacitance C_{P}.

Following this, a falling clock edge detection block 510 checks for a falling edge in the clock signal. Upon detection, another inductive path activation block 512 sets the driver to a high-impedance state and closes the inductive path switch again, enabling the inductor L_{X} to discharge and charge the parasitic capacitance C_{P} in the opposite direction.

The process then moves to another zero current detection block 514, which monitors if I_{LX} returns to zero. When I_{LX} substantially reaches zero, indicating that the charge on the parasitic capacitance C_{P} has been substantially restored, a final driver activation block 516 is activated. This block opens the inductive path switch, disabling the path, and turns on the second transistor M2, coupling the first terminal of the piezoelectric element 220 to the second supply voltage to finish restoring the voltage of the parasitic capacitance C_{P}.

This flowchart demonstrates a cyclical process that alternates between rising and falling clock edges, activating the inductive path and drivers accordingly. This sequence allows for efficient operation of the piezoelectric element by reusing the charge on its parasitic capacitance. In some cases, the sequence of operations may be controlled by a control circuit 306, which receives input from a clock signal source 200 and a current sensor 304, and provides control signals to the output stage 310 and the switch SW. In other cases, different control schemes may be used, depending on the specific requirements of the application.

Referring to FIG. 6, a circuit diagram is provided for an illustrative implementation of the switched inductance path. The circuit comprises a level shifter 602, a bidirectional sensor switch formed by transistors M4a and M4b, and a bidirectional switch formed by transistors M3a and M3b. The bidirectional sensor switch and bidirectional switch may be coupled in parallel between the inductor L_{X} and the ground terminal.

The level shifter 602 is connected to receive the switch control signal SW. The output of the level shifter 602 is connected to the gates of transistors for bidirectional switch M3a, M3b and to the gates of transistors for bidirectional sensor switch M4a, M4b. This configuration employs back-to-back n-channel DDMOS transistors to provide control of bidirectional current flows at elevated voltages with minimal on-resistance (e.g., 1 to 2 ohms).

The bidirectional sensor switch M4a, M4b is connected in series with a resistance R. This configuration allows for sensing the current through the inductor. The ratio of current flow between the bidirectional sensor switch M4a, M4b and the bidirectional switch M3a, M3b is governed by the relative sizes of the transistors M4a, M4b versus transistors M3a, M3b, with the bidirectional switch shunting most of the inductor current to ground. Resistance R coverts a sensing portion of the inductor current flow to a voltage signal I_{LX} that is proportional to the total inductor current flow.

The circuit of FIG. 6 is designed to enable control of inductor current flow for both voltage polarities. When the voltage across the switches is positive, transistors M3a and M4a block the current flow. When the voltage is negative, transistor M3b and M4b block the current flow. Together, this arrangement provides a means to sense the current and control the switching. This arrangement can be used to efficiently transfer energy stored in the parasitic capacitance of a piezoelectric element. While the configuration of FIG. 6 offers certain advantages in terms of performance and robustness, other switching and current sensor configurations are available in the published literature and would also be suitable for use herein. It is further noted that the components in this serial arrangement can be readily reordered while still providing similar results.

Referring to FIG. 7, an illustrative implementation of control circuit is shown. The illustrated control circuit 306 includes a flip-flop 702 with its data input D connected to a supply voltage VDD, representing a logical “1”. The flip-flop 702 has its clear input coupled to receive to a clear signal 704, which is generated by a logical XOR gate 706. The logical XOR gate 706 receives the clock signal directly as one input, and a delayed clock signal from a delay element 707 as the other input. This configuration causes the logical XOR gate 706 to momentarily assert the reset signal 704 whenever the clock signal has a transition. An inverter 708 inverts the reset signal 704 because the flip-flop 702 expects the reset signal in active-low form.

When the reset signal is asserted, the flip-flop 702 resets its output Q, causing its inverted output signal/Q to go high. This inverted output signal/Q is taken as the blanking signal (BL) and as the switch control signal (SW). When asserted, the switch control signal enables the switched inductance path to invert the polarity of charge on the parasitic capacitance. At the same time, the blanking signal is supplied to logic gates 301, 302 to inhibit activation of output stage transistors M1, M2.

Two comparators, 710 and 712, are shown with their inputs connected to receive the I_{LX} signal representing current measurements from an inductor. Comparator 710 asserts its output only when the I_{LX} signal is more than a threshold value above ground. Comparator 712 asserts its output only when the I_{LX} signal is more than a threshold value below ground. The outputs of these comparators feed into a logical NOR gate 714, which asserts its output only when I_{LX} is substantially equal to zero, indicating that current has ceased flowing in the inductor L_{X}. The output of gate 714 is taken as a clock input for flip-flop 702. When the clock input transitions from low to high, the flip-flop 702 latches the tied-high input and drive its output signal Q high and its inverted output signal/Q low. Thus, when the inductor current reaches zero, the switch control signal SW goes low, disabling the switched inductive path. At the same time, the blanking signal BL goes low, enabling the clock signal CLK to control the output stage transistors M1, M2.

This circuit configuration allows control of the output stage and switched inductive path to reuse the stored energy on the parasitic capacitance and reduce power dissipation in the output stage transistors. The control circuit 306 may be implemented using digital or analog circuitry, or a combination of both, depending on the specific requirements of the application.

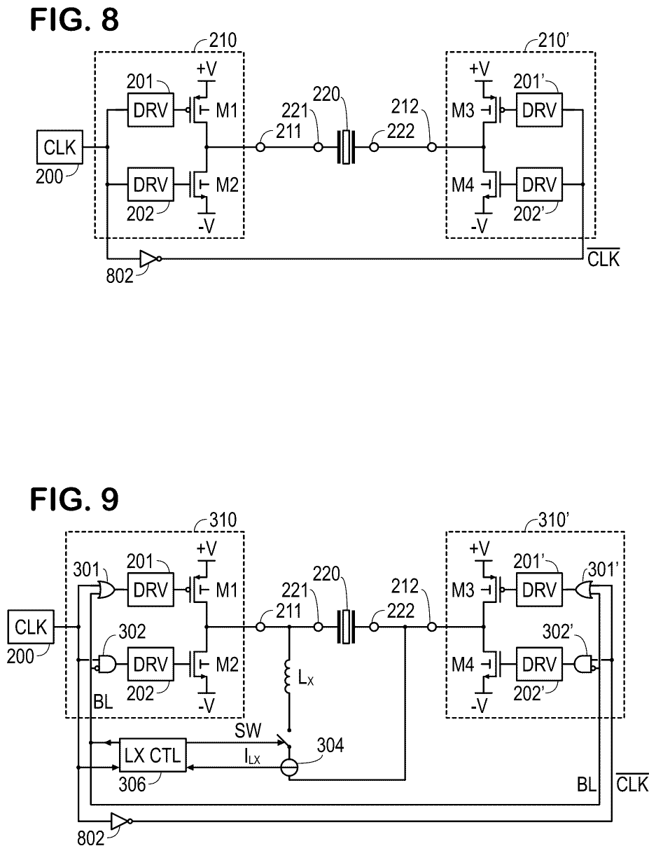

Other driver configurations can be similarly modified to provide a switched inductive path for reusing the stored energy on the parasitic capacitance. For comparison with the half-bridge driver configuration of FIG. 2A, FIG. 8 shows a full bridge driver configuration having the previously described half-bridge output stage 210 with output node 211 and a complementary half-bridge output stage 210′with a second output node 212. The clock signal for the complementary output stage 210′is provided by a logical NOT gate 802, causing the second output node 212 to be driven to the opposite supply voltage from the first output node 211. The first output node 211 is connected to the first terminal 221 of the piezoelectric element 220, and the second output node 212 is connected to the piezoelectric element's second terminal 222. As compared with the FIG. 2A configuration where one terminal of the piezoelectric element 220 is connected to ground, the full bridge driver configuration doubles the voltage across the piezoelectric element, or alternatively eliminates the need for a negative supply voltage (if, e.g., the low-side supply voltage in FIG. 8 is connected to ground).

FIG. 9 shows a full bridge driver configuration with the previously-described enhanced output stage 310 and a complementary output stage 310′. A switched inductor path (Inductor L_{X}, switch SW, and current sensor 304) is connected between the piezoelectric element's terminals 221, 222. Control circuit 306 controls the enhanced output stages 310, 310′and the switched inductor path as described previously to reuse the stored energy from the parasitic capacitance of piezoelectric element 220 and thereby enhance operating efficiency. This enhanced arrangement also achieves the advantages of the full bridge driver configuration but may require adjustment of the designs for the sensor 304 and switch SW to permit proper operation while floating relative to the low-side supply voltage.

Various implementations have been described. Those of ordinary skill having benefit of this disclosure will recognize other apparent variations, equivalents, and modifications that fall within the scope of the following claims. Where specific values are specified, those of ordinary skill will recognize that they have reasonable tolerances such that there exists a range of values that are considered substantially equal to the specific value. Typical tolerances are 5%, 10%, 15% of the specified value or of the typical measurement range for the given variable.

What is claimed is:

1. An actuator that comprises:
an output stage configured to alternately couple an output node to a first supply voltage and a second supply voltage, the output stage further configured to isolate the output node from each of the first supply voltage and the second supply voltage when an inhibit signal is asserted;
a piezoelectric element having two terminals coupled by a parasitic capacitance C_{P} and one of the two terminals coupled to the output node;
a switched inductance path between the two terminals, the switched inductance path including an inductor in series with a switch; and
a control circuit configured to close the switch as needed to substantially invert a charge on the parasitic capacitance before the output stage couples the first supply voltage or the second supply voltage to the output node.

2. The actuator of claim 1, wherein the second terminal is coupled to a ground voltage and the first supply voltage and the second supply voltage have substantially the same magnitude but opposite polarity relative to the ground voltage.

3. The actuator of claim 1, wherein the piezoelectric element has a characteristic resonance frequency f_{C}=1/2π(L_{S}C_{S})^{1/2}.

4. The actuator of claim 3, wherein the switched inductance path has an inductance L_{X} less than 1/(2πf_{C})²C_{P}.

5. The actuator of claim 1, wherein the output stage is configured to operate based at least in part on a clock signal having a drive frequency f_{D}.

6. The actuator of claim 5, wherein the switched inductance path has an inductance L_{X} less than 1/(2πf_{D})²C_{P}.

7. The actuator of claim 5, wherein the control circuit asserts the inhibit signal and closes the switch for each transition in the clock signal.

8. The actuator of claim 7, wherein the switched inductance path includes a current sensor configured to sense a current through the switched inductance path.

9. The actuator of claim 8, wherein the control circuit is configured to de-assert the inhibit signal and open the switch when the current substantially reaches zero.

10. A method of driving a piezoelectric element having a parasitic capacitance between its two terminals, the method comprising:
coupling a first terminal of the two terminals to a first supply voltage to charge the parasitic capacitance to a voltage relative to a second terminal of the two terminals;
decoupling the first terminal from the first supply voltage;
enabling an inductive path between the two terminals to substantially invert the voltage of the parasitic capacitance;
disabling the inductive path; and
coupling the first terminal to a second supply voltage to finish inverting the voltage of the parasitic capacitance.

11. The method of claim 10, further comprising:
decoupling the first terminal from the second supply voltage;
enabling the inductive path between the two terminals to substantially restore the voltage of the parasitic capacitance;
disabling the inductive path; and
coupling the first terminal to the first supply voltage to finish restoring the voltage of the parasitic capacitance.

12. The method of claim 11, wherein said decoupling and enabling operations are initiated by transitions in a clock signal.

13. The method of claim 12, wherein said disabling and coupling operations are enabled by a current sensor in the inductive path.

14. The method of claim 12, wherein the inductive path has an inductance L_{X} less than 1/(2πf_{D})²C_{P}, where f_{D} is a drive frequency of the clock signal.

15. The method of claim 10, wherein the inductive path has an inductance L_{X} less than 1/(2πf_{C})²C_{P}, where f_{C} is a characteristic resonance frequency of the piezoelectric element.

16. An actuator that comprises:
a piezoelectric element having two terminals coupled by a parasitic capacitance C_{P};
a first transistor configured to couple a first terminal of the two terminals to a first supply voltage to charge the parasitic capacitance to a voltage relative to a second terminal of the two terminals, and further configured to decouple the first terminal from the first supply voltage in response to a transition in a clock signal;
a switched inductance path between the two terminals configured to substantially invert the voltage of the parasitic capacitance in response to the transition, and further configured to isolate the two terminals when a current through the switched inductance path returns to zero; and
a second transistor configured to couple the first terminal to a second supply voltage to finish inverting the voltage of the parasitic capacitance when the current returns to zero.

17. The actuator of claim 16,
wherein the second transistor is further configured to decouple the first terminal from the second supply voltage in response to a second transition in the clock signal,
wherein the switched inductance path is configured to substantially restore the voltage of the parasitic capacitance in response to the second transition,
wherein the first transistor is configured to couple the first terminal to the first supply voltage to finish restoring the voltage of the parasitic capacitance when the current returns to zero.

18. The actuator of claim 17, further comprising a control circuit configured to inhibit the first transistor and the second transistor in response to each transition in the clock signal, and further configured to sustain the inhibition until the current returns to zero.

19. The actuator of claim 16, wherein the inductive path has an inductance L_{X} less than 1/(2πf_{D})²C_{P}, where f_{D} is a drive frequency of the clock signal.

20. The actuator of claim 16, wherein the inductive path has an inductance L_{X} less than 1/(2πf_{C})²C_{P}, where f_{C} is a characteristic resonance frequency of the piezoelectric element.
